(19) United States
(12) Patent Application Publication
(10) Pub. No.: US 2015/0028004 A1
(43) Pub. Date: Jan. 29, 2015

(54) METHOD FOR MARKING COMPONENTS EMPLOYING OVERLAPPING AND SUBSEQUENTLY BARELY OVERLAPPING LASER PULSES

(71) Applicant: SCHAEFFLER TECHNOLOGIES AG & CO. KG, Herzogenaurach (DE)

(72) Inventor: Mario Giese, Heroldsbach (DE)

(73) Assignee: Schaeffler Technologies GmbH & Co., KG, Herzogenaurach (DE)

(21) Appl. No.: 14/382,725

(22) PCT Filed: Feb. 12, 2013
(86) PCT No.: PCT/EP2013/052726

§ 371 Date: Sep. 3, 2014

(30) Foreign Application Priority Data
Apr. 5, 2012 (DE) DE102012205702.1

(51) Int. Cl. B23K 26/00; B41J 2/44

(52) U.S. Cl. CPC B23K 26/0081; B41J 2/442
USPC 219/121.66

(57) ABSTRACT

A method for marking components (2) by a plurality of pulses (4) of a pulsed beam of a laser is disclosed. At first, a melted burr is formed when the marking (2) is being created. Subsequently, the melted burr is removed, whereby the pulsed laser beam is moved over the melted burr at a second speed. The sequential pulses (4) hardly overlap or not at all.

The invention relates to a method for marking components. When it comes to the marking of components, the desired marking is applied onto a surface of a component by a plurality of pulses of a pulsed laser. The marking can be lettering or else a code (numerical code or barcode).

### BACKGROUND OF THE INVENTION

German Preliminary Published Application DE 10 2009 048 293 A1 discloses a workpiece that is provided with laser lettering as a security feature. The laser lettering can be seen with the naked eye and a machine-readable security identifier is provided underneath the laser lettering. The different depths present in the component are achieved by different depths of the heat-penetration zones of the laser radiation, thus creating the lettering.

German Preliminary Published Application DE 10 2009 048 291 A1 discloses a method for permanently marking a workpiece. For this purpose, first of all, the surface of the workpiece is treated with laser radiation, which causes a structural change in the workpiece. The surface exposed to the laser radiation is only ablated to such an extent that it cannot be visually distinguished, at least not with the naked eye, from the surrounding areas of the surface. A structural change is retained in the area of the workpiece that bears the marking.

Short-pulse lasers are often employed in order to create laser lettering (marking, identifier, security feature) in the surface of a workpiece. The workpiece can be a workpiece that has at least one metallic surface. The short-pulse lasers needed to create the marking are very expensive but they have the advantage that the material for the marking evaporates completely without leaving any residue. Commercially available lasers and less expensive lasers lave longer pulses and they entail the drawback that the material that is to be removed during the lettering does not evaporate completely. As a result, burrs remain at the sides of the marking or identifier, and this can interfere with the further use of the workpiece.

German patent application DE 40 12 279 A1 discloses a method for marking components by means of a plurality of pulses of a pulsed laser beam. Here, the laser beam is directed at a surface of a workpiece, a process in which melted burrs are formed at the side edges of a marking. In order to prevent the melted burrs, the proposal is made to provide the workpiece with an Eloxal layer.

European patent specification EP 1 333 976 B1 discloses the approach of coating a workpiece with a zinc layer in order to prevent the formation of melted burrs that surround the edges of the marking.

Moreover, German patent application DE 102 28 743 A1 discloses the approach of smoothing and polishing a surface of a workpiece using a pulsed laser beam.

### SUMMARY OF THE INVENTION

It is an object of the present invention to provide a method with which a commercially available laser can be used to make the marking on a component and with which, at the same time, no melted burrs are present after the marking has been created.

The present invention provides a method for marking components employs a plurality of pulses of a pulsed beam of a laser that is directed at a surface of the component. At first, a melted burr is formed at the side edges of the marking when the marking is being created. In order to make the marking, the pulsed laser beam is moved relative to the component at a first speed, so that the individual pulses of the laser beam overlap. Subsequently, the melted burr is removed, whereby the pulsed laser beam is moved over the melted burr at a second speed. In this process, the sequential pulses hardly overlap or not at all.

Finally, a subsequent melting of the edge areas of the marking can be carried out after the removal procedure. For this purpose, the laser beam is defocused and guided over the marking at a third speed. In this process, the laser beam acts upon the side edges of the marking at the same time. The defocusing reduces the output of the laser beam per unit surface area. The sequential pulses overlap here as well.

The third speed amounts to 400 mm/sec at a pulse frequency of 200,000 Hz. The second speed is 2500 mm/sec at a pulse frequency of 50,000 Hz.

The melted burr is formed by material of the component that did not evaporate completely when the marking was made.

The component that is provided with a marking can be a roller bearing. The melted burrs of the marking of the roller bearing are removed in such a way that the surface of the roller bearing can still function as a sealing surface.

The marking is made in the component during a sequence of several marking steps or method steps. First of all, ablation parameters are used with which is material evaporated. This gives rise to melted burrs at the edges of the marking. At the end of the marking procedure, a so-called cleaning sequence is carried out using the laser. The melted burrs that have been formed are once again removed in this process, whereby special cleaning parameters (laser-processing of the outer contour of the lettering at a high advance speed) are employed with little to no overlapping of the laser pulses and subsequent melting of the surface. The laser beam is defocused during the melting of the surface.

A special use of the method according to the invention entails the marking or lettering of layers whenever an extended durability of the lettering or security encoding is required. Since the melted burrs are removed—as a result of which ultimately few or no melted burrs are present any longer on the surface in which the lettering or marking has been created—this surface can still be used as a sealing surface, if necessary.

### BRIEF DESCRIPTION OF THE DRAWINGS

The invention will be described in greater detail below on the basis of an embodiment making reference to the accompanying drawings. The following is shown:

FIG. 1 a schematic arrangement of a laser that is employed for lettering a component;

FIG. 2 a top view of the surface of a component in which a marking has been made by means of intersecting or overlapping laser pulses;

FIG. 3 a schematic sectional view along the line A-A shown in FIG. 2, whereby the melted burrs are present at the side edges of the marking;

FIG. 4 a top view of the surface of a component, whereby the edges are processed by non-overlapping laser pulses, so that the melted burrs can be removed;

FIG. 5 a schematic sectional view along the line B-B shown in FIG. 4, illustrating the result of the removal of the melted burrs; and

FIG. 6 a schematic top view of the surface of a component, whereby the edges of the marking are melted by means of a defocused and pulsed laser.

### DETAILED DESCRIPTION

Identical reference numerals are employed for equivalent or functionally identical elements of the invention. The embodiment presented constitutes merely one way in which the melted burrs can be removed when markings are made in components.

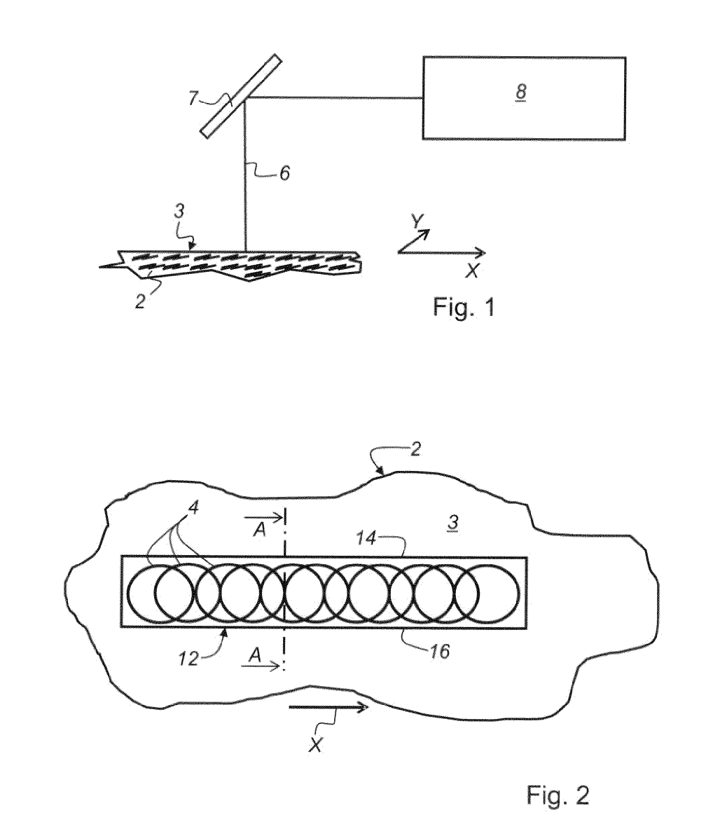

FIG. 1 shows a schematic view of an arrangement with which markings, lettering or security identifiers can be made in the surface 3 of a component 2. The arrangement consists of a laser 8 that emits a beam 6. The laser beam 6 is made up of a consecutive sequence of laser pulses. A scanning device 7 moves the laser beam over the surface 3 of the component 2 at a certain speed, thus creating the markings or identifiers in the surface 3 of the component 2 in any desired form. The laser beam can be moved by the scanning device 7 in the x-coordinate direction as well as in the y-coordinate direction.

FIG. 2 shows a top view of a section of the surface 3 of the component 2. The marking 12 is created in the surface 3 of the component 2 by a plurality of laser pulses 4. Consequently, the marking 12 comprises a first edge 14 and a second edge 16. By means of the scanning unit 7 shown in FIG. 1, the laser pulses are moved at a certain speed, as shown in FIG. 2, in the x-coordinate direction, thus forming the desired shape of the marking 12.

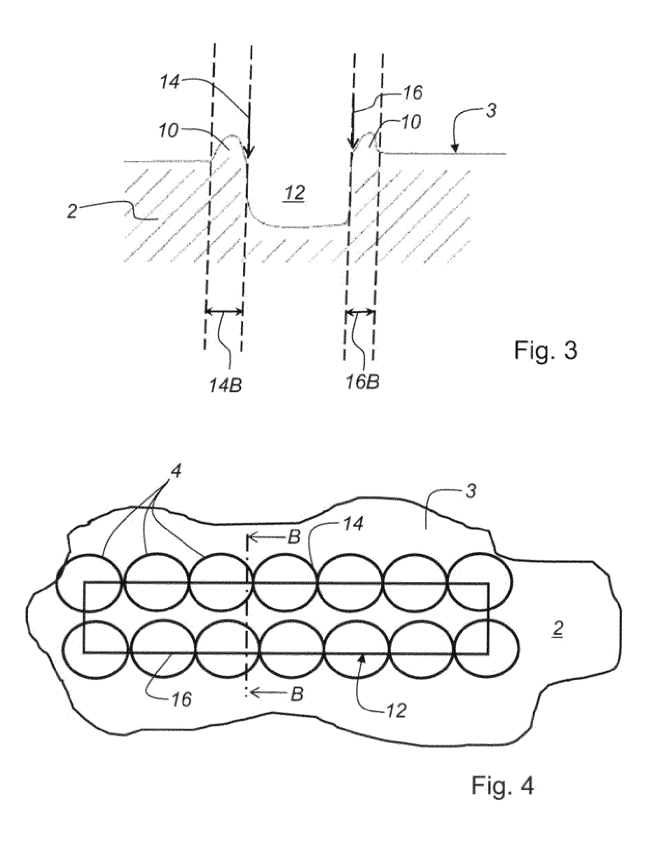

FIG. 3 shows a schematic sectional view along the line A-A. Melted burrs 10 that are formed due to material of the component that has not evaporated completely appear at the first edge 14 and at the second edge 16. The melted burrs 10 are formed on the surface 3 of the component 2. Therefore, the melted burrs 10 occupy a certain edge area 14B around the first edge 14 as well as 16B around the second edge 16.

FIG. 4 shows a schematic top view of the surface 3 of the component 2, whereby the melted burrs 10 shown in FIG. 3 are removed. The pulsed laser beam is moved along the edge areas 14B and 16B at a second speed that is greater than the first speed. In this context, the speed at which the scanning device 7 can be set is dimensioned such that the individual sequential pulses 4 of the laser beam 6 do not overlap at all or else only very slightly.

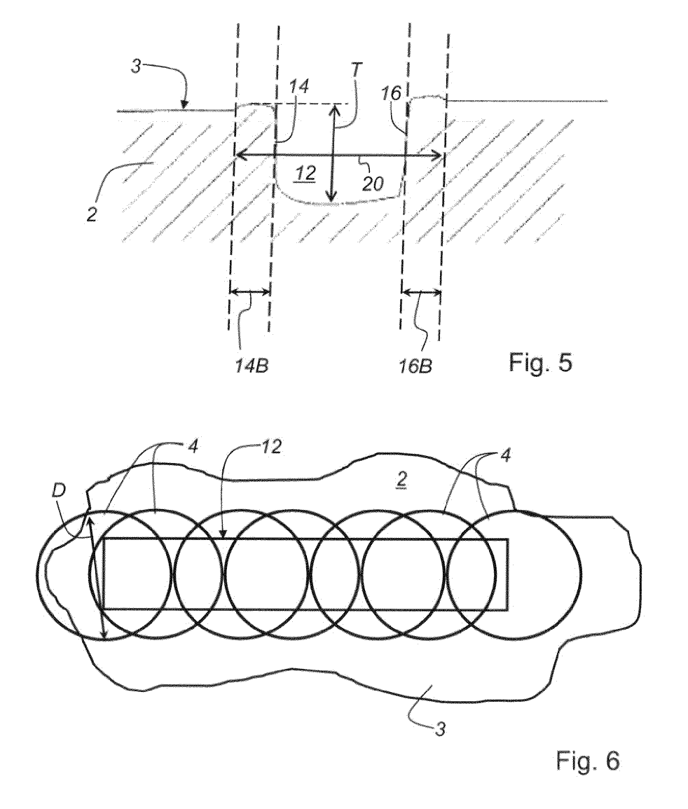

FIG. 5 shows a cross sectional view along the line B-B depicted in FIG. 4. The removal of the melted burrs 10 means that the melted burrs 10 recede almost to the level of the surface 3 of the component 2. In a last step, as shown in FIG. 6, the edge areas 14B and 16B can undergo a melting procedure. For this purpose, the laser beam 6 is defocused and the individual laser pulses 4 are moved over the formed marking 12 at a third speed. The defocusing of the laser beam 6 here is dimensioned in such a way that the diameter D of the defocused laser beam 6 is greater than the distance 20 between the edge area 14B and the edge area 16B.

In some application areas, the marking 12 created with the laser should have a depth T of 10 μm, whereby the melted burrs 10 may only amount to 1 μm at the maximum. The method according to the invention employs various parameters with which the surface 3 of the workpiece or component 2 is processed. Owing to the sequence of the deep engraving (creation of the marking 12) and the subsequent cleaning by means of the laser 8, one obtains an outer contour from which the melted burrs have been removed. The cleaning by means of the laser 8 is likewise carried out using special cleaning parameters. The created marking 12 or deep engraving remains legible after the melted burrs 10 have been removed. It is highly probable that this marking 12 or deep engraving will remain legible, even after a prolonged service life of the workpiece or component 2. This ensures protection against fraud, even after a long service life of, for instance, a roller bearing.

1-7. (canceled)

8. A method for marking components by a plurality of pulses of a pulsed beam of a laser directed at a surface of the component, the method comprising the following steps:
forming a melted burr at side edges of the marking when the marking is being created whereby, during the creation of the marking, the pulsed laser beam is moved relative to the component at a first speed, so that the pulses overlap; and
removing the melted burr, the pulsed laser beam being moved over the melted burr at a second speed so that the sequential pulses do not overlap or overlap insubstantially.

9. The method as recited in claim 8 wherein, after the removal, edge areas of the marking are subsequently melted, the laser beam is defocused and, at the same time, guided over the side edges of the marking at a third speed.

10. The method as recited in claim 9 wherein the third speed amounts to 400 mm/sec at a pulse frequency of 200,000 Hz.

11. The method as recited in claim 8 wherein the second speed is 2500 mm/sec at a pulse frequency of 50,000 Hz.

12. The method as recited in claim 8 wherein the melted burr is formed by material of the component not evaporating completely when the marking was made.

13. The method as recited in claim 8 wherein the component is a roller bearing that is provided with the marking.

14. The method as recited in claim 8 wherein the melted burrs of the marking of the roller bearing are removed in such a way that the surface of the roller bearing can still function as a sealing surface.
